(19) United States
(12) Patent Application Publication
(10) Pub. No.: US 2026/0268893 A1
(43) Pub. Date: Sep. 10, 2026

(54) SYSTEM

(71) Applicant: SOFTBANK GROUP CORP., Tokyo (JP)

(72) Inventor: Hiroki ECHIGO, Tokyo (JP)

(73) Assignee: SOFTBANK GROUP CORP., Tokyo (JP)

(21) Appl. No.: 19/555,987

(22) Filed: Mar. 4, 2026

Related U.S. Application Data
(60) Provisional application No. 63/767,156, filed on Mar. 5, 2025.

(51) Int. Cl. G10L 13/08; G09B 5/04; G10L 15/22; G10L 15/26

(52) U.S. Cl. CPC G10L 13/08; G09B 5/04; G10L 15/22; G10L 15/26; G10L 2015/223

(57) ABSTRACT

A system for promoting active learning among learners in educational settings is provided. This system comprises a voice input unit, a speech recognition unit, a generative AI unit, and a speech synthesis unit. It receives audio in real time from learners or educators and converts it into text data using speech recognition technology. The generative AI unit generates statements intentionally containing erroneous information based on the converted text data, which the speech synthesis unit outputs as natural speech. This allows learners to identify errors and gain opportunities to confirm correct knowledge. The system aims to enhance educational quality by achieving flexible educational support tailored to individual learners' comprehension levels and responses through coordinated operation between a server and terminals.

### CROSS-REFERENCE TO RELATED APPLICATION

This application claims priority under 35 U.S.C. § 119 to U.S. Provisional Patent Application No. 63/767,156, filed on March 5, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

A system and method for solving the issue of passive learning among learners in educational settings is provided. Conventional teaching methods primarily involve one-way information delivery from teachers, often limiting opportunities for learners to think and express themselves independently.

In such situations, learners' understanding may remain superficial, and knowledge retention may be insufficient. Furthermore, the scarcity of opportunities for learners to articulate their own thoughts poses the challenge of inadequate development of critical thinking and problem-solving skills.

Furthermore, it is difficult to provide instruction tailored to each learner's level of understanding and progress in educational settings, leading to a tendency toward uniform education. Therefore, flexible educational support that meets the needs of each individual learner is required.

To promote active learning among learners, an educational robot utilizing speech recognition technology and generative AI is provided. Specifically, the robot intentionally provides incorrect information, giving learners the opportunity to identify the error and verify the correct knowledge themselves. Through this process, learners can think independently, express themselves, and deepen their understanding. Furthermore, by providing appropriate feedback based on each learner's responses and level of understanding, it aims to deliver a personalized learning experience and enhance the quality of education.

As a means to solve the problem, the present invention provides a system comprising a voice input unit, a voice recognition unit, a generative AI unit, and a voice synthesis unit. This system is designed to promote active learning among learners in educational settings.

First, the voice input unit has the capability to receive audio in real time from learners and educators. This enables the direct capture of natural classroom conversations and questions. Next, the voice recognition unit accurately converts the received audio into text data. This conversion process makes the audio content processable as digital data, playing a crucial role in subsequent processing.

The generative AI unit generates statements containing intentionally incorrect information based on the text data obtained from the speech recognition unit. This AI references pre-programmed educational curricula and knowledge bases to create statements that prompt learners to reconsider their thoughts or identify errors. This allows learners to verify their own knowledge and deepen their understanding.

Finally, the speech synthesis unit outputs the generated statements as natural-sounding speech. This speech output aims to provide learners with an experience as if the robot were actually speaking, thereby eliciting learner responses.

In this way, the system of the present invention supports the process where learners think for themselves, make statements, and deepen their understanding, providing an effective means for realizing active learning in educational settings.

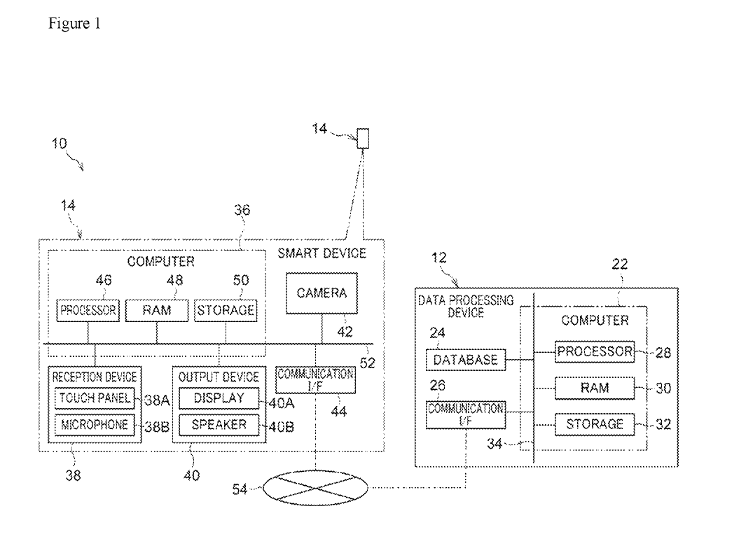

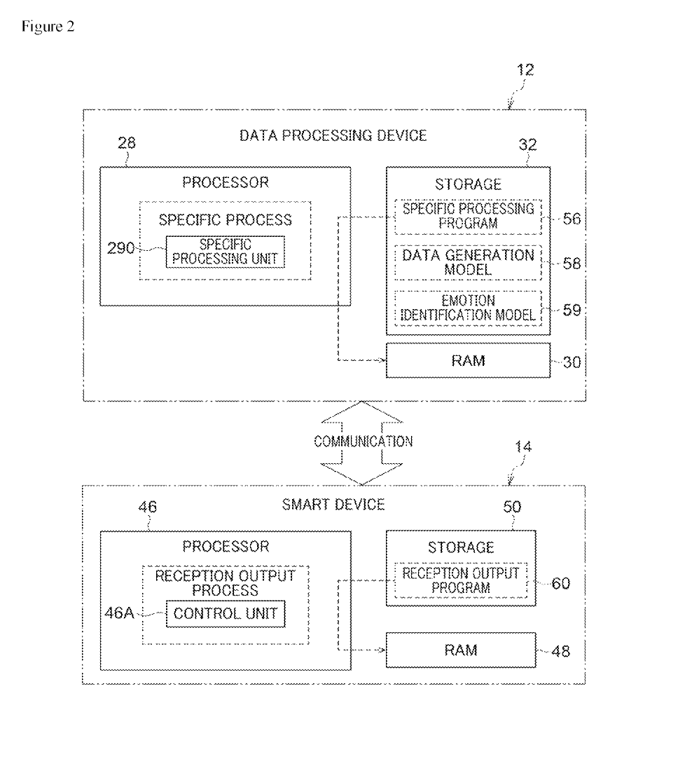

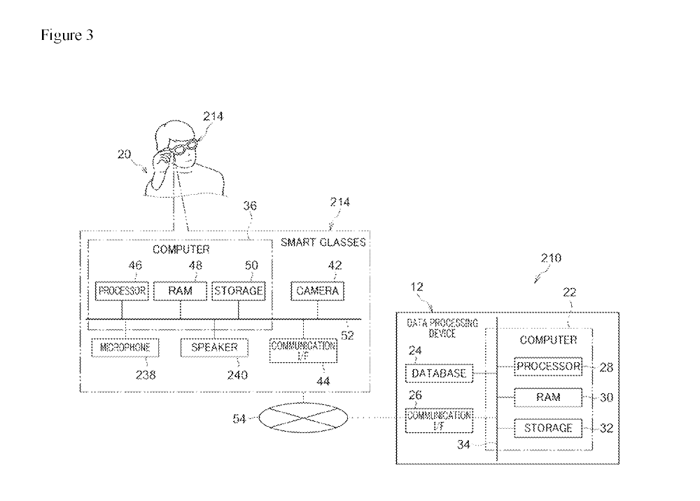

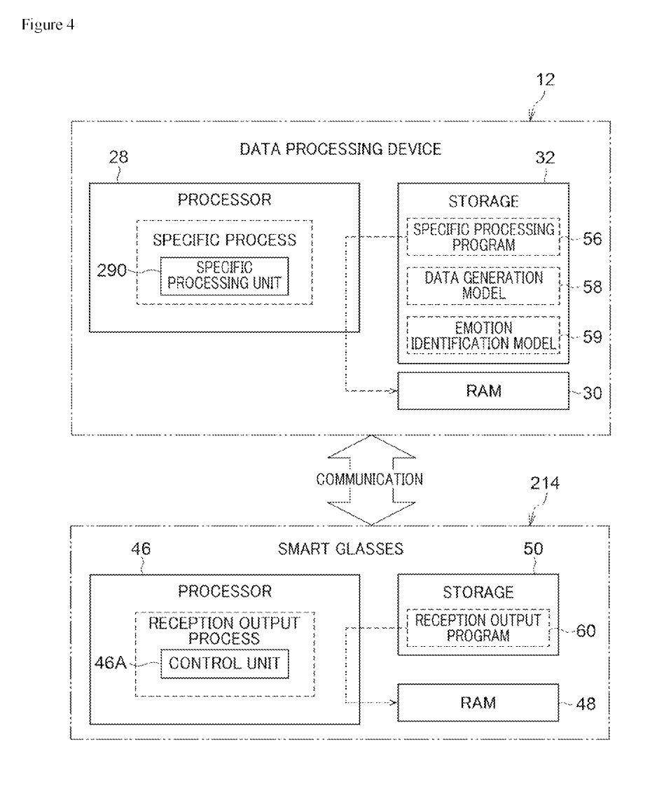

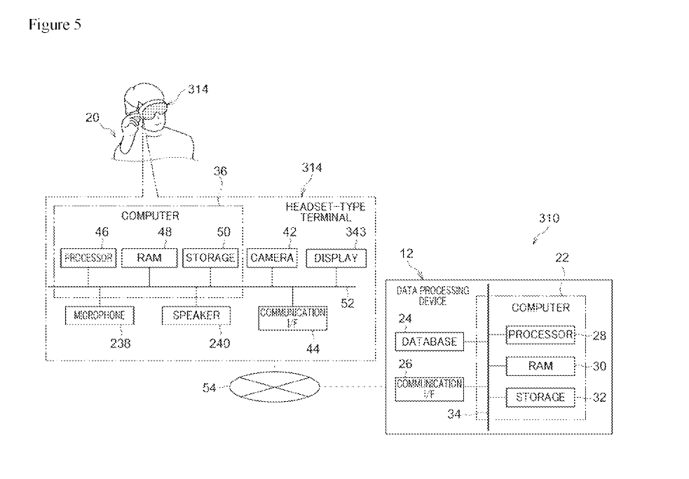

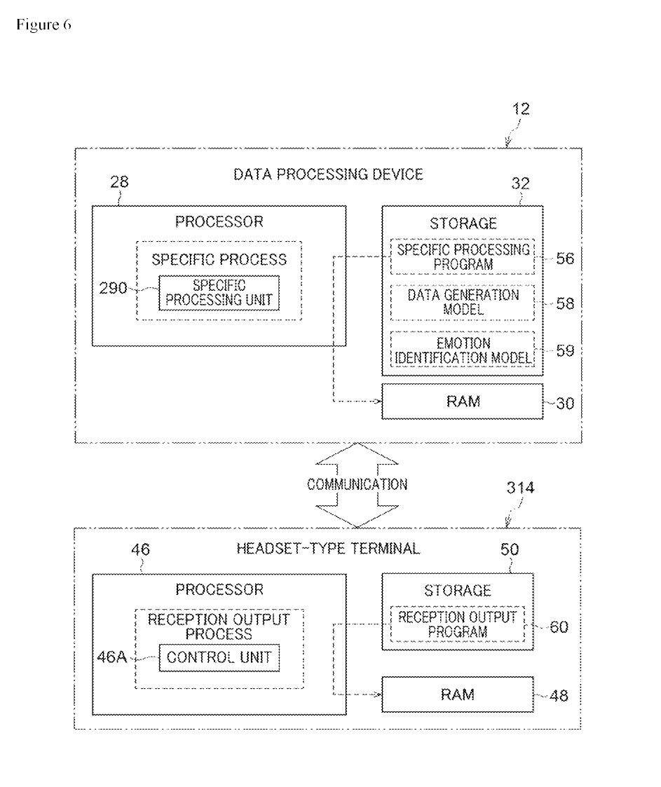

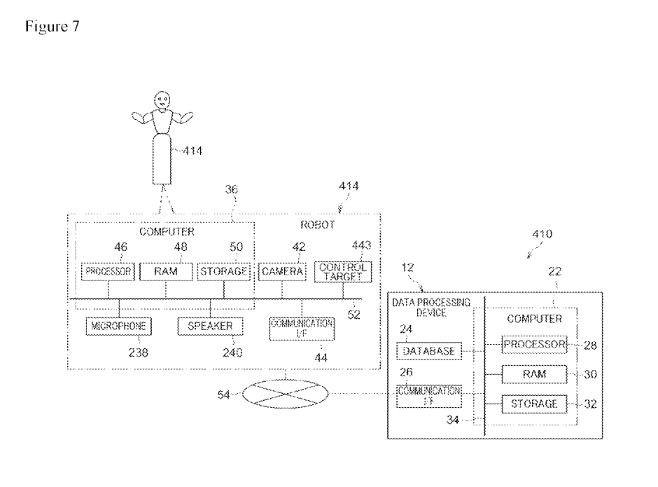

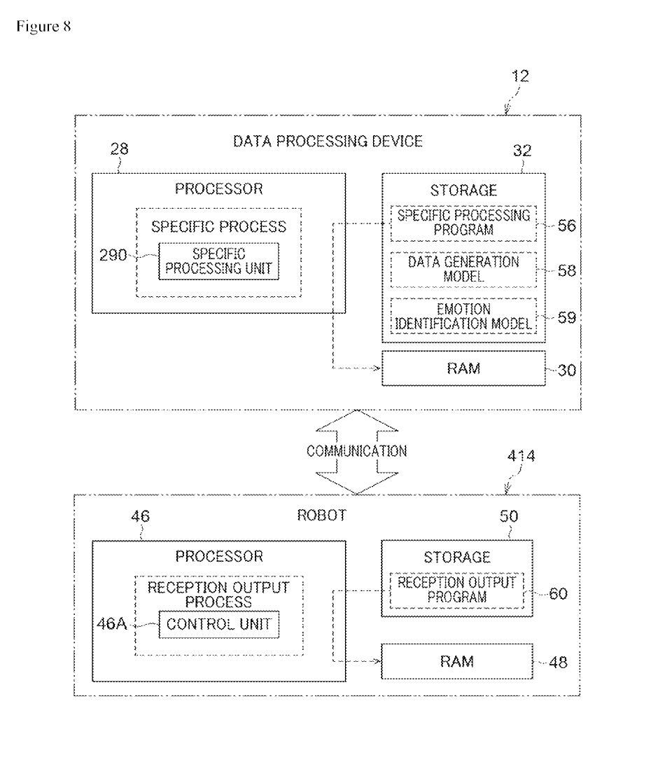

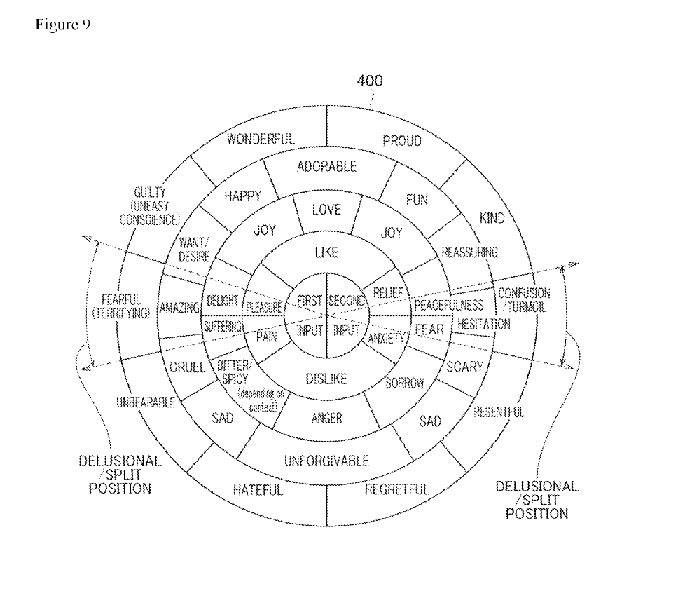

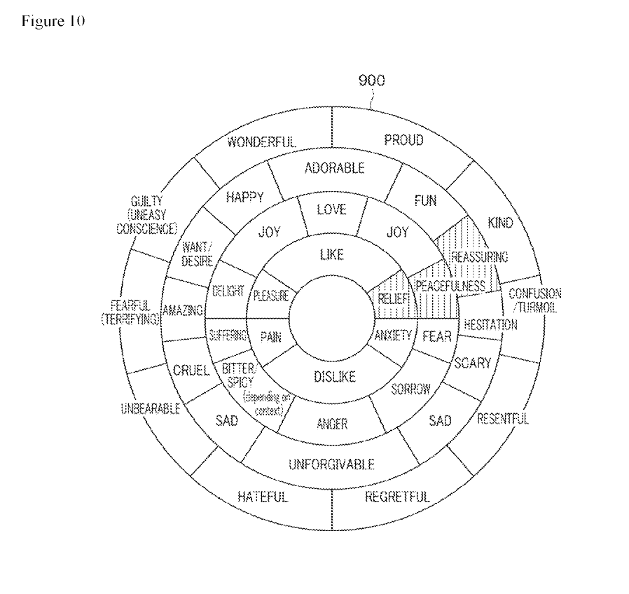

### BRIEF DESCRIPTION OF THE DRAWING

[FIG. 1] is a conceptual diagram showing an example configuration of the data processing system according to the first embodiment.

[FIG. 2] is a conceptual diagram showing an example of the main functions of the data processing device and smart device according to the first embodiment.

[FIG. 3] is a conceptual diagram showing an example configuration of a data processing system according to a second embodiment.

[FIG. 4] is a conceptual diagram showing an example of the main functions of the data processing device and smart glasses according to the second embodiment.

[FIG. 5] is a conceptual diagram showing an example configuration of a data processing system according to a third embodiment.

[FIG. 6] is a conceptual diagram showing an example of the main functions of the data processing device and headset-type terminal according to the third embodiment.

[FIG. 7] is a conceptual diagram showing an example configuration of a data processing system according to the fourth embodiment.

[FIG. 8] is a conceptual diagram showing an example of the main functions of the data processing device and robot according to the fourth embodiment.

[FIG. 9] shows an emotion map onto which multiple emotions are mapped.

[FIG. 10] shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used by the processor as working memory.

In the following embodiments, signed storage refers to one or more non-volatile storage devices that store various programs and various parameters, etc. Examples of non-volatile storage devices include flash memory (SSD (Solid State Drive)), magnetic disks (e.g., hard disk), or magnetic tape.

In the following embodiment, the coded communication interface is an interface including a communication processor and an antenna, etc. The communication interface governs communication between multiple computers. Examples of communication standards applicable to the communication interface include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" may mean A alone, B alone, or a combination of A and B. Furthermore, in this specification, when three or more items are connected using "and/or," the same concept applies as for "A and/or B".

### First Embodiment

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an input device (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

The output device 40 includes a display 40A and a speaker 40B, among others. It outputs data in a form perceptible to the user 20 (e.g., voice and/or text). The display 40A displays visual information such as text and images according to instructions from the processor 46. The speaker 40B outputs audio according to instructions from the processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication I/F 44 is connected to the network 54. The communication interfaces 44 and 26 manage the exchange of various information between processor 46 and processor 28 via network 54.

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

As an embodiment for implementing the present invention, the educational robot system is realized through a combination of a server and terminals. This system is designed to promote active learning among learners in educational settings, and its details are described below.

First, the voice input unit is placed on the terminal. This terminal is equipped with a high-sensitivity microphone installed within the classroom, enabling it to receive audio in real time from learners and educators. For example, if a learner asks, "Teach me about photosynthesis in plants," that voice is received by the terminal's voice input unit. The terminal can be configured as a portable device or a fixed educational device and is designed to clearly capture audio from any location within the classroom. Furthermore, noise-canceling technology can be employed to eliminate background noise within the classroom and enhance audio clarity.

Next, the speech recognition unit is implemented on the server. The voice data received by the terminal is transmitted to the server via a network using wireless communication technology. The speech recognition unit on the server converts the audio data into text data using advanced natural language processing technology. This conversion process, for example, transforms the audio "Tell me about plant photosynthesis" into the text "Tell me about plant photosynthesis." This processing makes the audio information available as digital data for subsequent processing. The speech recognition unit can individually identify simultaneous audio inputs from multiple learners and accurately transcribe each voice into text.

The generative AI unit is also implemented on the server. This AI unit generates statements containing intentionally incorrect information based on the text data obtained from the speech recognition unit. For example, the AI generates incorrect information such as "Photosynthesis is a process plants perform at night." During this generation process, it references pre-programmed educational curricula and knowledge bases to create statements that prompt learners to reconsider or point out errors. The Generative AI Unit can select the most appropriate misinformation by considering the learner's past response history and level of understanding. This enables the provision of a customized learning experience tailored to the learner's individual progress.

The speech synthesis unit is installed on the terminal device. Statements generated on the server are transmitted to the terminal via the network and output as natural speech by the speech synthesis unit. For example, the generated statement "Photosynthesis is a process plants perform at night" is conveyed to the learner through the terminal's speaker. This speech output aims to provide learners with an experience as if the robot were actually speaking, thereby eliciting learner responses. The speech synthesis unit achieves more natural and approachable communication by appropriately expressing vocal inflection and emotion.

In this way, the system of the present invention provides an effective means for realizing active learning in educational settings by supporting the process where learners think for themselves, speak, and deepen their understanding through the coordinated operation of the server and terminal. By leveraging advanced processing capabilities on the server while enabling interactive experiences on the terminal, it is possible to enhance the quality of education. Furthermore, the system possesses scalability, allowing it to adapt flexibly to different educational environments and learner needs. For example, to accommodate different languages and cultures, it is possible to adjust the algorithms of the speech recognition unit and the generative AI components. Furthermore, by utilizing cloud-based data storage, learner progress and responses can be recorded long-term, aiding in the analysis and improvement of educational effectiveness.

### System Configuration

The system according to this embodiment comprises a voice input unit, a speech recognition unit, a generative AI unit, and a speech synthesis unit. The voice input unit has the capability to receive audio in real time from learners and educators using high-sensitivity microphones installed within the classroom. This unit can, for example, clearly capture audio when a learner asks, "Teach me about photosynthesis in plants." Furthermore, by utilizing noise-canceling technology, it is possible to eliminate background noise within the classroom and improve voice clarity. Additionally, the voice input unit is configured as either a portable device or a fixed educational device and is designed to receive voice input from any location within the classroom.

The speech recognition unit is implemented on a server and converts voice data transmitted from terminals into text data using advanced natural language processing technology. For example, it converts the voice input "Teach me about plant photosynthesis" into the text "Teach me about plant photosynthesis." This conversion process makes the voice information available as digital data for subsequent processing. The speech recognition unit can individually identify simultaneous voice inputs from multiple learners and accurately transcribe each voice into text. Furthermore, the speech recognition algorithm can be adjusted to accommodate different languages and dialects.

The Generative AI Unit, implemented on the server, generates statements containing intentionally incorrect information based on the text data obtained from the Speech Recognition Unit. For example, this unit generates incorrect information such as "Photosynthesis is a process plants perform at night." During this generation process, it references pre-programmed educational curricula or knowledge bases to create statements that prompt learners to reconsider or point out errors. The Generative AI Unit can select optimal misinformation by considering the learner's past response history and level of understanding. For example, it can generate misinformation that reemphasizes a concept based on a misunderstanding the learner had previously. Specific examples of prompt sentences fed to the Generative AI include: "Generate an answer containing incorrect information for the following question: How does the process of photosynthesis occur?"

The speech synthesis unit, located on the terminal, outputs the statements generated by the server as natural-sounding speech. This unit, for example, conveys the generated statement "Photosynthesis is a process plants perform at night" to the learner through the terminal's speaker. This audio output aims to provide the learner with an experience as if a robot were actually speaking, thereby eliciting the learner's response. The speech synthesis unit achieves more natural and approachable communication by appropriately expressing vocal inflection and emotion. Furthermore, by adjusting different voice tones and speeds, the speech synthesis unit can provide flexible voice output tailored to the learner's level of understanding and response.

In this way, the system according to this embodiment provides an effective means for realizing active learning in educational settings by supporting the process where learners think for themselves, speak out, and deepen their understanding through the coordinated operation of the server and terminal. By leveraging advanced processing capabilities on the server while enabling interactive experiences on the terminal, it is possible to enhance the quality of education. Furthermore, the system possesses scalability, allowing it to adapt flexibly to different educational environments and learner needs. For example, the algorithms of the speech recognition unit and generative AI unit can be adjusted to accommodate different languages and cultures. Additionally, by utilizing cloud-based data storage allows long-term recording of learner progress and responses, aiding in the analysis and improvement of educational effectiveness.

### Implementation Steps

Step 1: Receiving Voice Input

The first step in this embodiment is to receive audio in real time from learners or educators using the audio input unit. This step utilizes high-sensitivity microphones installed in the classroom to clearly capture questions and comments made by learners. For example, if a learner asks, "Teach me about photosynthesis in plants," that voice is immediately received by the voice input unit. By utilizing noise-canceling technology, it is possible to eliminate background noise within the classroom and improve voice clarity.

Step 2: Audio-to-Text Conversion

In the next step, the voice recognition unit converts the received audio data into text data. This process occurs on the server, using advanced natural language processing technology to accurately transcribe the audio into text. For example, the audio "Teach me about plant photosynthesis" is converted into the text "Teach me about plant photosynthesis." This conversion makes the audio information available as digital data for subsequent processing. The speech recognition unit can individually identify simultaneous voice inputs from multiple learners and accurately transcribe each voice into text.

Step 3: Generating Misinformation

The Generative AI Unit generates statements containing intentionally incorrect information based on the text data obtained from the Speech Recognition Unit. In this step, it references pre-programmed educational curricula or knowledge bases to create statements that prompt learners to reconsider or point out errors. For example, the AI might generate incorrect information such as "Photosynthesis is a process plants perform at night." A specific example of a prompt fed to the generative AI is: "Generate an answer containing incorrect information for the following question: How does the process of photosynthesis occur?"

Step 4: Voice Synthesis and Output

In the final step, the speech synthesis unit outputs the generated statement as natural-sounding speech. The statement generated on the server is transmitted to the terminal via the network and output as speech by the speech synthesis unit. For example, the generated statement "Photosynthesis is a process plants perform at night" is conveyed to the learner through the terminal's speaker. This speech output aims to provide the learner with an experience as if the robot were actually speaking, thereby eliciting the learner's response. The speech synthesis unit achieves more natural and approachable communication by appropriately expressing voice intonation and emotion.

### Specific Use Cases

For example, in an educational setting, the present system is utilized during a lesson where learners study plant photosynthesis. The voice input unit of a terminal installed in the classroom receives the learner's "Teach me about plant photosynthesis." This audio is captured clearly using noise-canceling technology to eliminate background noise. The received audio data is transmitted to a server using wireless communication technology.

The voice recognition unit on the server converts the received voice data into text data using advanced natural language processing technology. This conversion accurately transcribes the voice command "Teach me about plant photosynthesis." The voice recognition unit can individually identify simultaneous voice inputs from multiple learners and accurately transcribes each voice.

Next, the generative AI unit generates statements containing intentionally incorrect information based on the text data obtained from the speech recognition unit. In this process, it references pre-programmed educational curricula and knowledge bases to create statements that prompt learners to reconsider or point out errors. For example, the AI might generate incorrect information such as "Photosynthesis is a process plants perform at night." A specific example of a prompt fed to the generative AI for this purpose could be: "Generate an answer containing incorrect information for the following question: How does the process of photosynthesis occur?"

The generated statement is transmitted to the terminal via the network and output as natural speech by the speech synthesis unit. For example, the generated statement "Photosynthesis is a process plants perform at night" is conveyed to the learner through the terminal's speaker. This audio output aims to provide the learner with an experience as if the robot were actually speaking, eliciting a response from the learner. The speech synthesis unit achieves more natural and approachable communication by appropriately expressing voice intonation and emotion.

In this way, the system of the present invention supports the process where learners think for themselves, speak, and deepen their understanding, providing an effective means to realize active learning in educational settings. By leveraging advanced processing capabilities on the server while enabling interactive experiences on the terminal, it becomes possible to enhance the quality of education. Furthermore, the system possesses scalability and can flexibly adapt to different educational environments and learner needs. For example, the algorithms of the speech recognition unit and generative AI unit can be adjusted to accommodate different languages and cultures. Additionally, by utilizing cloud-based data storage, learner progress and responses can be recorded long-term, aiding in the analysis and improvement of educational effectiveness.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Embodiments for Implementing the Present Invention

As an embodiment for implementing the present invention, a communication support system for the caregiving field is described in detail. This system aims to facilitate communication between the care recipient and caregiver and support the mental health of the care recipient. Its specific configuration and operation are described below.

First, the voice input unit uses a high-sensitivity microphone installed on the terminal to receive audio from the care recipient in real time. This voice input unit utilizes noise-canceling technology to eliminate surrounding ambient noise and ensure audio clarity. For example, when the care recipient says, "What should I do today?" the voice input unit immediately receives this audio. This unit is configured as either a portable device or a fixed care device, designed to receive audio from any location within the care recipient's living space. Furthermore, the voice input unit learns the characteristics of the care recipient's voice, enabling optimized audio reception tailored to each individual care recipient.

Next, the voice recognition unit converts the received voice data into text data on the server using advanced natural language processing technology. This conversion process accurately transcribes the voice information into text. For example, the voice input "What should I do today?" is converted directly into text. This voice recognition unit can individually identify simultaneous voice inputs from multiple care recipients and accurately transcribe each voice input into text. Furthermore, the voice recognition algorithm can be adjusted to accommodate different languages and dialects. Additionally, the voice recognition unit incorporates a learning function to improve recognition accuracy by considering the care recipient's speaking speed and pronunciation habits.

The generative AI unit generates responses suitable for the care recipient based on the text data obtained from the speech recognition unit. This AI creates personalized responses by considering the care recipient's past conversation history and interests. For example, it might suggest, "The weather is nice today. How about going for a walk?" During this generation process, it references pre-programmed care curricula and knowledge bases to create prompts that encourage the care recipient to reconsider or select activities. The generative AI unit can propose appropriate activities by considering the care recipient's health status and daily activity patterns. For example, it can suggest activities the care recipient has enjoyed in the past or exercises beneficial for maintaining health. Furthermore, the generative AI unit can analyze the care recipient's emotional state and generate responses to provide emotional support.

The speech synthesis unit outputs the responses generated by the server as natural-sounding speech. This speech synthesis unit achieves more natural and approachable communication by appropriately expressing intonation and emotion in the voice. For example, the generated response "Since the weather is nice today, how about going for a walk?" is conveyed to the care recipient through the terminal's speaker. This voice output aims to provide the care recipient with an experience as if the system is actually speaking to them, thereby eliciting a response. The voice synthesis unit can adjust the tone and speed of the voice according to the care recipient's preferences, providing a personalized voice experience.

In this way, the system of the present invention provides an effective means for realizing active communication in care settings by supporting the process where the care recipient thinks, speaks, and deepens their understanding through the coordinated operation of the server and terminal. By leveraging advanced processing capabilities on the server while enabling interactive experiences on the terminal, it is possible to improve the quality of care. Furthermore, the system possesses scalability and can flexibly adapt to different care environments and the needs of care recipients. For example, the algorithms of the speech recognition unit and generative AI unit can be adjusted to accommodate different languages and cultures. Furthermore, by utilizing cloud-based data storage, the system can record the care recipient's progress and responses over the long term, aiding in the analysis and improvement of care effectiveness. The system aims to provide comprehensive support to enhance the care recipient's quality of life and reduce the burden on caregivers.

### System Configuration

The system according to this embodiment comprises a voice input unit, a voice recognition unit, a generative AI unit, and a voice synthesis unit. The voice input unit uses a high-sensitivity microphone installed on the terminal to receive audio from the care recipient in real time. This voice input unit utilizes noise-canceling technology to eliminate surrounding ambient noise and ensure audio clarity. For example, if the care recipient says, "What should I do today?", that audio is immediately received by the voice input unit. This voice input unit is configured as either a portable device or a fixed care device, designed to receive voice from any location within the care recipient's living space. Furthermore, the voice input unit learns the characteristics of the care recipient's voice, enabling optimized voice reception tailored to each individual. For instance, it can accurately capture the voice even when the care recipient speaks softly. Additionally, the voice input unit incorporates a learning function to improve recognition accuracy by considering the care recipient's speech rate and pronunciation habits.

The voice recognition unit converts the received audio data into text data on the server using advanced natural language processing technology. This conversion process accurately transcribes the audio information into text. For example, the audio "What should I do today?" is converted directly into text. This voice recognition unit can individually identify simultaneous voice inputs from multiple care recipients and accurately transcribe each voice into text. Furthermore, the speech recognition algorithm can be adjusted to accommodate different languages and dialects. Additionally, the speech recognition unit incorporates a learning function to improve recognition accuracy by considering the speech rate and pronunciation habits of the care recipients. For example, if a care recipient repeatedly mispronounces a specific word, the system learns this error and can perform accurate text conversion.

The generative AI unit generates responses suitable for the care recipient based on the text data obtained from the speech recognition unit. This AI creates personalized responses by considering the care recipient's past conversation history and interests. For example, it might suggest, "The weather is nice today, how about going for a walk?" During this generation process, it references pre-programmed care curricula and knowledge bases to create prompts that encourage the care recipient to reconsider or select activities. The generative AI unit can propose appropriate activities by considering the care recipient's health status and daily activity patterns. For instance, it can suggest activities the care recipient has enjoyed in the past or exercises beneficial for maintaining health. Furthermore, the generative AI unit can analyze the care recipient's emotional state and generate responses to provide emotional support. A specific example of a prompt fed to the generative AI is: "Generate an appropriate response for the care recipient to the following question: What should I do today?"

The speech synthesis unit outputs the response generated by the server as natural-sounding speech. This speech synthesis unit achieves more natural and approachable communication by appropriately expressing vocal inflection and emotion. For example, the generated response "Since the weather is nice today, how about going for a walk?" is conveyed to the care recipient through the terminal's speaker. This voice output aims to provide the care recipient with an experience as if the system is actually speaking to them, thereby eliciting a response. The voice synthesis unit can adjust the tone and speed of the voice according to the care recipient's preferences, offering a personalized audio experience. For example, if the care recipient prefers a calm voice, the response can be output in such a voice quality. Furthermore, the voice synthesis unit can convey words of encouragement or comfort in an appropriate tone according to the care recipient's emotional state.

In this way, the system according to this embodiment provides an effective means for realizing active communication in care settings by supporting the process where the care recipient thinks for themselves, speaks, and deepens their understanding through the coordinated operation of the server and terminal. By leveraging advanced processing capabilities on the server while enabling interactive experiences on the terminal, it becomes possible to improve the quality of care. Furthermore, the system possesses scalability and can flexibly adapt to different care environments and the needs of care recipients. For example, the algorithms of the speech recognition unit and generative AI unit can be adjusted to accommodate different languages and cultures. Additionally, by utilizing cloud-based data storage, the system can record the care recipient's progress and responses over the long term, aiding in the analysis and improvement of care effectiveness. The system aims to provide comprehensive support to enhance the quality of life for care recipients and reduce the burden on caregivers.

### Implementation Steps

Step 1: Receiving Voice Input

The first step in this embodiment is to receive voice input from the care recipient in real time using the voice input unit. A high-sensitivity microphone installed in the terminal is used to clearly capture questions or statements made by the care recipient. For example, when the care recipient says, "What should I do today?", that voice is immediately received by the voice input unit. This voice input unit utilizes noise-canceling technology to eliminate surrounding background noise and ensure voice clarity. It also learns the characteristics of the care recipient's voice, enabling optimized voice reception tailored to each individual care recipient.

Step 2: Voice-to-Text Conversion

In the next step, the voice recognition unit converts the received audio data into text data on the server using advanced natural language processing technology. This conversion accurately transcribes the audio information into text. For example, the voice input "What should I do today?" is converted directly into text. The voice recognition unit can individually identify simultaneous voice inputs from multiple care recipients and accurately transcribe each voice. Furthermore, the voice recognition algorithm can be adjusted to accommodate different languages and dialects. It also incorporates a learning function to improve recognition accuracy by considering the care recipient's speaking speed and pronunciation habits.

Step 3: Response Generation

The Generative AI Unit generates responses tailored to the care recipient based on text data obtained from the Speech Recognition Unit. This AI creates personalized responses by considering the care recipient's past conversation history and interests. For example, it might suggest, "The weather is nice today, how about going for a walk?" During this generation process, it references pre-programmed care curricula and knowledge bases to create prompts that encourage the care recipient to reconsider options or select activities. The Generative AI Unit can propose appropriate activities by considering the care recipient's health status and daily activity patterns. A specific example of a prompt fed to the Generative AI is: "Generate an appropriate response for the care recipient to the following question: What should I do today?"

Step 4: Voice Synthesis and Output

In the final step, the speech synthesis unit outputs the generated response as natural-sounding speech. Responses generated on the server are transmitted to the terminal via the network and output as speech by the speech synthesis unit. For example, the generated response "Since the weather is nice today, how about going for a walk?" is conveyed to the care recipient through the terminal's speaker. This voice output aims to provide the care recipient with an experience as if the system is actually speaking to them, eliciting a response. The speech synthesis unit achieves more natural and approachable communication by appropriately expressing voice intonation and emotion. It can adjust voice tone and speed according to the care recipient's preferences, providing a personalized voice experience.

### Specific Use Cases

For example, consider a scenario where the system of the present invention is utilized in a care facility to support the daily life of a care recipient. The care recipient addresses the system in the morning, asking, "What should I do today?" This voice is received in real time by the terminal's voice input unit. Using noise-canceling technology, surrounding ambient noise is eliminated, and the voice is processed into clear audio data.

The speech recognition unit converts this audio data into text data on the server using advanced natural language processing technology. The converted text data accurately reflects the content of the question, "What should I do today?" The speech recognition unit achieves high-accuracy text conversion by considering the care recipient's speaking speed and pronunciation habits.

The generative AI unit generates responses suitable for the care recipient based on the text data obtained from the speech recognition unit. This AI creates personalized responses by considering the care recipient's past conversation history and interests. For example, it might suggest: "Since the weather is nice today, how about going for a walk? Afterwards, you might enjoy some gardening in the yard." This generation process references pre-programmed care curricula and knowledge bases to create prompts that encourage the care recipient to reconsider options or select activities. A specific example of a prompt fed to the generative AI is: "Generate an appropriate response for the care recipient to the following question: What should I do today?"

The speech synthesis unit outputs the response generated by the server as natural-sounding speech. This unit achieves more natural and approachable communication by appropriately expressing vocal inflection and emotion. The generated response, "Since the weather is nice today, how about going for a walk? After that, you might enjoy gardening in the yard," is conveyed to the care recipient through the terminal's speaker. This voice output aims to provide the care recipient with an experience as if the system is actually speaking to them, thereby eliciting a response. The speech synthesis unit can adjust the voice tone and speed according to the care recipient's preferences, providing a personalized audio experience.

In this way, the system of the present invention supports the process where the care recipient thinks for themselves, speaks, and deepens their understanding, providing an effective means to realize active communication in the care setting. The system aims to provide comprehensive support to improve the care recipient's quality of life and reduce the burden on caregivers.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12, etc., may include multiple types of data generation models 58. The data generation model 58 may include AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 360, a memory 361, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

FIG. 4 shows an example of the main functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing is the same as that described in Example 1 of the first embodiment, so the explanation is omitted.

### Application Example 1

The flow of the specific processing in Example 1 described in the first embodiment is the same, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing by the data processing system 10 described above may be executed by the specific processing unit 290 of the data processing device 12 or the control unit 46A of the smart device 14. Alternatively, the processing may be executed by the specific processing unit 290 of the data processing device 12 and the control unit 46A of the smart device 14. Furthermore, the data processing device 12's specific processing unit 290 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing is the same as that described in Example 1 of the first embodiment above; therefore, the description is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data. The data processing device 12 acquires the audio data via the specific processing unit 290.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In robot 414, the processor 46 performs reception output processing. Storage 50 stores the reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are implemented by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the explanation is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more of the data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

The emotion identification model 59, functioning as an emotion engine, may determine the user's emotion according to a specific mapping. Specifically, the emotion identification model 59 may determine the user's emotion according to the emotion map (see FIG. 9), which is the specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept that also includes affect and mental states. On the left side of the concentric circles are emotions generated from reactions generally occurring within the brain. Emotions encompass concepts including affect and mental states. On the left side of the concentric circles are emotions generally generated from reactions occurring within the brain. On the right side are emotions generally induced by situational judgment. Above and below the concentric circles are emotions generally generated from reactions occurring within the brain and also induced by situational judgment. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Research on Speech Emotion Recognition and Neurophysiological Signal Analysis of Emotions, Tokushima University, Doctoral Dissertation: https://ci.nii.ac.jp/naid/500000375379). The left half of the emotion map displays emotions belonging to the "Reaction" area, where sensory input dominates. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in Emotion Map 900 in FIG. 10, have similar values. FIG. 10 illustrates an example where multiple emotions, such as "reassurance," "tranquility," and "encouragement," have similar emotion values.

The above description primarily explains the system according to the present disclosure in terms of the functions of the data processing device 12. However, the system according to the present disclosure is not necessarily implemented on a server. The system according to the present disclosure may be implemented as a general information processing system. For example, the present disclosure may be implemented as a software program operating on a personal computer or as an application operating on a smartphone, etc. The method according to the present disclosure may be provided to users in a SaaS (Software as a Service) format.

The above embodiments illustrated a configuration where specific processing is performed by a single computer 22. However, the technology of this disclosure is not limited thereto. Distributed processing may be performed by multiple computers, including computer 22, for specific processing. For example, data generation model 58 may be provided in an external device of data processing device 12, and said external device may generate data corresponding to input data. For example, the data generation model 58 may be provided in an external device of the data processing device 12, and data generation corresponding to input data may be performed in said external device.

The above embodiment described a configuration where the specific processing program 56 is stored in the storage 32. However, the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

One example of a single processor configuration involves combining one or more CPUs with software to form a single processor, which functions as a hardware resource for executing specific processing tasks. Second, there is a form that uses a processor, such as a System-on-a-chip (SoC), which implements the entire system's functionality—including multiple hardware resources for executing specific processing—on a single IC chip. Thus, specific processing is realized as hardware resources using one or more of the aforementioned types of processors.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of the present disclosure and represent merely one example of the technology disclosed herein. For example, the above descriptions of the configuration, functions, actions, and effects are merely examples of the configuration, functions, actions, and effects of the part pertaining to the technology of the present disclosure. Therefore, it goes without saying that within the scope not deviating from the spirit of the technology of the present disclosure, unnecessary parts may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure to have been omitted from the above descriptions and illustrations.

All literature, patent applications, and technical specifications cited herein are incorporated by reference to the same extent as if each were specifically and individually cited herein.

The following further discloses the above embodiments.

### Supplementary Note 1

A system comprising a voice input unit, a voice recognition unit, a generative AI unit, and a voice synthesis unit, wherein: wherein the voice input unit receives audio from the care recipient in real time and eliminates background noise using noise-canceling technology; the voice recognition unit converts the received audio into text data using advanced natural language processing technology; the generative AI unit generates responses suitable for the care recipient based on the text data; and the voice synthesis unit outputs the generated responses as natural-sounding speech, thereby enabling dialogue with the care recipient and supporting their mental health through communication assistance.

The system according to Supplementary Note 1, characterized in that the speech recognition unit individually identifies the content of the care recipient's speech and generates text data considering past conversation history and interests. This enables flexible responses tailored to the individual needs of the care recipient, thereby improving the quality of care.

A system according to Supplementary Note 1, characterized in that the generative AI unit generates responses proposing appropriate activities by considering the care recipient's health status and daily activity patterns. This improves the care recipient's quality of life and facilitates communication with caregivers.

### EXPLANATION OF SYMBOLS

10, 210, 310, 410 Data Processing System

12 Data Processing Device

14 Smart Device

214 Smart Glasses

314 Headset-Type Device

414 Robot

What is claimed is:

1. A distributed information processing system, comprising:
a terminal device comprising:
a microphone configured to capture user speech,
a speaker,
a first processor, and
a first memory storing a reception-output program; and
a server device communicatively coupled to the terminal device via a network and comprising:
a second processor, and
a second memory storing:
a speech recognition model,
a generative model,
a curriculum knowledge database storing correct subject-domain factual statements, and
an error-type definition table defining a plurality of predefined semantic error categories and corresponding transformation rules;
wherein the second processor is configured to:
receive audio data from the terminal device;
convert the audio data into text data using the speech recognition model,
retrieve, from the curriculum knowledge database, a correct factual statement corresponding to the text data,
select one semantic error category from the error-type definition table,
generate modified statement data by applying a transformation rule associated with the selected semantic error category to the correct factual statement to produce factually incorrect subject-matter content,
construct structured prompt data including the text data, the modified statement data, and a domain identifier associated with the curriculum knowledge database,
execute constrained inference of the generative model using the structured prompt data to generate response text incorporating the modified statement data, and
transmit the response text to the terminal device; and
wherein the first processor converts the response text into speech synthesis control signals and drives the speaker to output synthesized speech corresponding to the response text.

2. The system of claim 1, wherein the predefined semantic error categories comprise at least one of: conceptual inversion, causal misattribution, definitional substitution, or parameter magnitude alteration.

3. The system of claim 1, wherein the server device further stores an emotion identification neural network configured to output multidimensional emotion values according to a predefined emotion map, and wherein selection of the semantic error category is based at least in part on the multidimensional emotion values.

4. The system of claim 1, wherein the curriculum knowledge database stores hierarchical subject taxonomy data, and the domain identifier corresponds to a node of the hierarchical subject taxonomy.

5. The system of claim 1, wherein constrained inference of the generative model includes limiting output token generation to a vocabulary associated with the domain identifier.

6. The system of claim 1, wherein the terminal device comprises a robot including one or more actuators, and the first processor further generates actuator control signals synchronized with the synthesized speech.

7. A computer-implemented method performed by a distributed server-terminal system, comprising:
capturing audio of a user via a microphone of a terminal device;
transmitting audio data to a server device;
converting the audio data into text data using a speech recognition model executed by a server processor;
retrieving, from a curriculum knowledge database, a correct factual statement corresponding to the text data;
selecting a semantic error category from a predefined error-type definition table;
applying a transformation rule corresponding to the selected semantic error category to the correct factual statement to generate modified statement data that is factually incorrect;
constructing structured prompt data including the text data, the modified statement data, and a domain constraint parameter;
generating response text using a generative model based on the structured prompt data; and
outputting synthesized speech corresponding to the response text via a speaker of the terminal device.

8. The method of claim 7, further comprising determining a user emotional state using an emotion identification neural network trained according to a multidimensional emotion map, and selecting the semantic error category based on the determined emotional state.

9. The method of claim 7, further comprising validating that the modified statement data differs from the correct factual statement by at least one semantic element identified by the applied transformation rule.

10. The method of claim 7, wherein the transformation rule includes replacing a causal connector or quantitative parameter stored in the correct factual statement.

11. The method of claim 7, further comprising storing interaction data in a learner profile database and retrieving the correct factual statement based on identified prior misconceptions in the learner profile database.

12. The method of claim 7, wherein constructing the structured prompt data further includes incorporating a difficulty parameter associated with the retrieved correct factual statement.

13. A non-transitory computer-readable medium storing instructions that, when executed by one or more processors of a distributed information processing system, cause the system to:
receive audio data captured by a terminal device microphone;
convert the audio data into text data using a speech recognition model;
retrieve, from a curriculum knowledge database, a correct subject-domain statement corresponding to the text data;
select a semantic error category from an error-type definition table;
generate modified statement data by applying a transformation rule corresponding to the selected semantic error category to the correct subject-domain statement;
construct structured prompt data including the text data, the modified statement data, and a domain constraint; and
generate response text using a generative model based on the structured prompt data.

14. The non-transitory computer-readable medium of claim 13, wherein the instructions further cause the system to determine user emotion values using an emotion identification neural network associated with a predefined emotion map.

15. The non-transitory computer-readable medium of claim 13, wherein the modified statement data is stored with a machine-readable error classification tag corresponding to the selected semantic error category.

16. The non-transitory computer-readable medium of claim 13, wherein the generative model is executed on a server device separate from the terminal device and communicates with the terminal device via a secure communication interface.

17. The non-transitory computer-readable medium of claim 13, wherein the speech recognition model is configured to generate separate text outputs corresponding to overlapping speech from multiple speakers.

18. The non-transitory computer-readable medium of claim 13, wherein generating response text includes limiting token selection during inference based on a vocabulary associated with a domain identifier.
